(19) United States
(12) Patent Application Publication
(10) Pub. No.: US 2007/0009628 A1
(43) Pub. Date: Jan. 11, 2007

(54) Systems and methods for attaching and aligning a tamperhead in production machinery

(75) Inventor: Vincent Ishler, Mercersburg, PA (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: Rampf Molds Industries, Inc., Hagerstown, MD (US)

(21) Appl. No.: 11/481,416

(22) Filed: Jul. 6, 2006

Related U.S. Application Data
(60) Provisional application No. 60/697,546, filed on Jul. 11, 2005.

(51) Int. Cl. A01J 21/00; B23Q 3/00

(52) U.S. Cl. 425/431; 29/464; 29/467

(57) ABSTRACT

The present invention generally pertains to a locking pin system for installing a tamperhead into production machinery. The system may include at least one locking pin having a retaining groove which is mounted on the tamperhead. The system allows the tamperhead to move relative to the production machinery until the pin is locked with respect to the production machinery. The production machinery includes an opening which may be configured to receive the locking pin. During use, the pin may be inserted into the opening in the production machinery and the tamperhead may be moved into alignment. Once the tamperhead is aligned, the pin may be locked to prevent further movement of the tamperhead.

### RELATED U.S. APPLICATIONS

This application claims the benefit of U.S. provisional Application No. 60/697,546, filed Jul. 11, 2005 and entitled “Apparatus and Method for a Self-Adjusting Tamperhead Locking System.” The foregoing application is hereby incorporated herein by reference.

### FIELD OF THE INVENTION

The invention generally relates to concrete-based product making machinery. More particularly, the invention relates to systems and methods for attaching and aligning a tamperhead in concrete-based product making machinery.

### BACKGROUND OF THE INVENTION

Concrete masonry units are typically produced using a production machine and a mold assembly. Generally, the mold assembly includes a mold having mold cavities and a tamperhead, both of which must be installed and aligned in the production machinery. The production machinery may drive the tamperhead into the mold to strip formed and compacted concrete products from the mold cavities.

The tamperhead may be composed of several sub-components which may include an upper head structure, a plunger and a stripper shoe. Multiple sets of stripper shoes and plungers may be connected to a single head structure and may be used to strip multiple masonry units from one or more molds or a set of concrete mold cavities. The plungers are commonly fabricated in structural shapes, depending on the shape and type of concrete units being formed. Plungers typically manufactured from a rigid material, such as steel, and are attached on one end to the head structure and on the other end to the stripper shoe. The plungers provide the structural load path to compress the concrete and strip the formed concrete product from the mold.

Generally, a concrete production machine is used with different mold assemblies, each corresponding to a specific type of concrete product (for example, bricks, paving stones, etc.). During ordinary production conditions, the mold assemblies are changed out of production machinery two to four times per day. In order to maximize production time, it is desirable for the machine operators to minimize the amount of time spent changing the machinery.

Some systems use a quick-change tamperhead to reduce the amount of time necessary for a change. These tamperheads utilize head locking pins which act to secure the tamperhead to the production machinery by interacting with locking ram forks of the production equipment. Typically, the forks are wedge-shaped and the pins are fabricated with a matching angle to accept the locking forks. When the forks are driven into the corresponding angle of the pins, usually using hydraulic means, the tamperhead is pulled tight against the machine compression beam.

Unfortunately, this production machinery does not include alignment capabilities to adjust for any misalignments between the tamperhead and the mold when the tamperhead is changed. To insure proper alignment between the tamperhead and the mold, the bolts that fasten the locking pins are generally manually loosened during the installation process, allowing the tamperhead to shift about the locking pins while a machine operator aligns the tamperhead with the mold. Then, once the tamperhead and the mold are aligned, the bolts for the locking pins are retightened and the production machinery may then be operated.

There are several drawbacks and disadvantages of this technique. For example, the operating conditions and workspace for accessing the locking pins and bolts may be unsafe. The mold assembly is installed in a severely space-constrained area in the vicinity of dangerously heavy moving parts. Thus, requiring an operator to access the pins and bolts may be a safety hazard to that operator.

Additionally, despite the convenience offered by quick-locking pins, loosening and retightening the bolts for alignment is time consuming, thereby reducing the amount of time the machinery is available for the production of concrete products. As a result, some machine operators may use only the locking pins and forego the alignment process altogether which can result in damage to the equipment or substandard concrete products.

However, unaligned mold assemblies may be subject to additional forces not seen during normal production. Therefore, when the alignment process is foregone, the mold and tamperhead may be subject to excessive wear and, in some cases, catastrophic failure. As such, the tamperhead and mold may need to be replaced and/or repaired more frequently than properly aligned machinery.

Finally, even where the alignment process is used by an operator, human error may still result in the tamperhead being improperly installed. As the production machinery is operating, the tamperhead may release from the locking pin bolts and may crash down onto the mold cavities, damaging the mold assembly and the production machinery.

Therefore, there exists a need for a tamperhead that may be quickly installed while still providing for the alignment of the tamperhead and the mold prior to use in the production of molded products.

### SUMMARY OF THE INVENTION

The invention generally relates to concrete-based product making machinery. More particularly, the invention relates to a system for a attaching and aligning a tamperhead in concrete-based product making machinery.

In one embodiment, the present invention may include a system for aligning a tamperhead with a mold in production machinery. The system may comprise at least one pin movably held by the tamperhead and an opening in the production machinery associated with the at least one pin. The opening may be configured to receive the at least one pin and the tamperhead may be permitted to move relative to the at least one pin when the at least one pin is received by the opening, thereby allowing the tamperhead to be aligned with the mold.

In another embodiment, the present invention may include a method for aligning a tamperhead with a mold in production machinery, the tamperhead having at least one movably held pin. The method may comprise the steps of inserting the at least one movably held pin into an opening in the production machinery and aligning the tamperhead with the mold by moving the tamperhead with respect to the at least one movably held pin. Additionally, the method may comprise the step of attaching the tamperhead to the production machinery after the tamperhead is aligned with the mold so that the tamperhead is prevented from further movement with respect to the at least one movably held pin.

In another embodiment, the present invention may include a system for aligning a tamperhead with a mold in production machinery, the system comprising an upper head plate attached to a tamperhead, the upper head plate having a first side and a second side, an alignment pin located on the first side of said upper head plate and a screw attached to said alignment pin. Additionally, the system may include an alignment opening in the upper head plate configured to receive the screw, the alignment opening having a diameter larger than the screw such that the upper head plate is capable of moving relative to said screw and a machine head plate having an associated opening, the associated opening being configured to receive the alignment pin. Further, the upper head plate may be permitted to move relative to the screw and the machine head plate when the alignment pin is received by the alignment opening, thereby allowing alignment of the tamperhead with a mold.

In another embodiment, the present invention may include a system for aligning a tamperhead with a mold in production machinery, the system comprising an upper head plate attached to a tamperhead, an alignment pin, an alignment plate attached to the alignment pin and a pair of opposing alignment shelves attached to the upper head plate. The alignment shelves may be configured to movably hold the alignment plate such that the upper head plate is capable of moving relative to the alignment plate. The system may also comprise a machine head plate having an associated opening, the associated opening being configured to receive the alignment pin wherein the upper head plate is permitted to move relative to the alignment plate and the machine head plate when the alignment pin is received by the alignment opening, thereby allowing alignment of the tamperhead with a mold.

In another embodiment, the present invention may include a system for aligning a tamperhead with a mold in production machinery, the system comprising an upper head plate attached to a tamperhead, the upper head plate having an alignment position and a locking position, an alignment pin and an alignment plate attached to the alignment pin. The system may also comprise at least two lever arms pivotally attached to the upper head plate, each of the lever arms having a first end and a second end and a machine head plate having an associated opening, the associated opening being configured to receive the alignment pin, wherein when the upper head plate is in the alignment position, the first end of each of the lever arms protrudes through an opening in the upper head plate and the second end of each of said lever arms is configured to movably hold the alignment plate such that the upper head plate is capable of moving relative to the alignment plate and wherein when the upper head plate is in the locking position, the first end of each of the lever arms is engaged with the machine head plate and the second end of each of the lever arms forces the alignment plate to engage with the upper head plate such that the upper head plate is prevented from moving relative to the alignment plate.

The present invention may include a self-adjusting tamperhead locking system comprising free-floating tamperhead locking pins. The free-floating pins may allow the tamperhead to shift relative to the locking pins and align with the mold cavities during installation, without the need to loosen and retighten the bolts of the locking pins. The system may be designed in such a way as to lock itself when the machine head locks are engaged.

The self-adjusting tamperhead locking system and method of the present invention may assure correct adjustment of various tamperhead and mold combinations. During installation, the tamperhead and the mold may be engaged such that the stripper shoes of the tamperhead are placed within the mold cavities and inherently aligned. The system of the present invention may assure alignment by allowing the tamperhead to free-float relative to the locking pins until the machine head locks engage. Once engaged, the self-adjusting locking pins and the machine head locks may secure the tamperhead in the engaged position, with the stripper shoes placed within the mold cavities.

The system and method of the present invention may allow machine operators to install or change out mold assemblies without adjustment of tamperhead locking pins, as required by previous production equipment. This may remove the possibility of human error during the alignment portion of the installation process. Additionally, it removes the risk associated with skipping the alignment during installation.

Further, the system and method of the present invention may allow for reduced machinery change-out time and, thus, increased production time. Furthermore, the system and method may be completely compatible with existing production machinery that is equipped to work with the previous quick-change tamperheads and traditional locking pins.

These and other objects and advantages of the invention will be apparent from the following description, the accompanying drawings and the appended claims.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows a mold assembly according to one embodiment of the present invention.

FIG. 2 shows a side view of a tamperhead locking system according to one embodiment of the present invention.

FIG. 3 shows another side view of a tamperhead locking system according to the embodiment of the present invention shown in FIG. 2.

FIG. 4 shows another side view of a tamperhead locking system according to the embodiment of the present invention shown in FIG. 2.

FIG. 5 shows another side view of a tamperhead locking system according to the embodiment of the present invention shown in FIG. 2.

FIG. 6 shows another side view of a tamperhead locking system according to the embodiment of the present invention shown in FIG. 2.

FIG. 7 shows a side view of another tamperhead locking system according to one embodiment of the present invention.

FIG. 8 shows another side view of a tamperhead locking system according to the embodiment of the present invention shown in FIG. 7.

FIG. 9 shows another side view of a tamperhead locking system according to the embodiment of the present invention shown in FIG. 7.

FIG. 10 shows another side view of a tamperhead locking system according to the embodiment of the present invention shown in FIG. 7.

FIG. 11 shows another side view of a tamperhead locking system according to the embodiment of the present invention shown in FIG. 7.

FIG. 12 shows a side view of another tamperhead locking system according to one embodiment of the present invention.

FIG. 13 shows another side view of a tamperhead locking system according to the embodiment of the present invention shown in FIG. 13.

FIG. 14 shows another side view of a tamperhead locking system according to the embodiment of the present invention shown in FIG. 13.

### DETAILED DESCRIPTION OF THE INVENTION

The present disclosure will now be described more fully with reference to the Figures in which various embodiments of the present invention are shown. The subject matter of this disclosure may, however, be embodied in many different forms and should not be construed as being limited to the embodiments set forth herein.

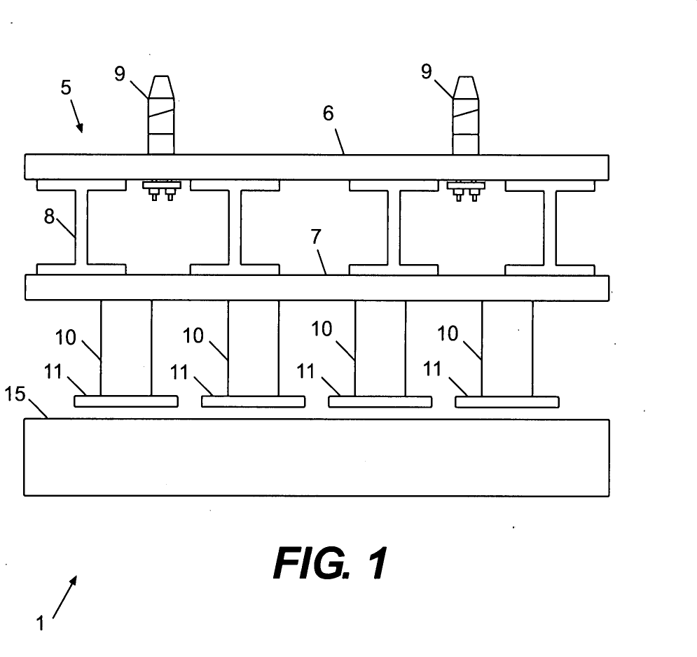

FIG. 1 shows a mold assembly 1 according to one embodiment of the present invention. As illustrated in FIG. 1, the mold assembly 1 may include a tamperhead 5 and a mold 15. In one embodiment of the present invention, the tamperhead 5 may include an upper plate 6 and a lower plate 7. Additionally, the tamperhead 5 may include supports 8 to provide structural integrity and rigidity to the tamperhead 5. A plurality of plungers 10 having stripper shoes 111 may be attached to the lower plate 7. The stripper shoes 11 may be adapted to substantially fill corresponding mold cavities (not shown) in the mold 15 to produce the concrete products, as discussed above.

While a tamperhead 5 having an upper plate 6, a lower plate 7, supports 8 and a plurality of plungers 10 and stripper shoes 11 is shown in FIG. 1, it is contemplated that the present invention may be used with any tamperhead to be used in production machinery for producing molded products. This may include, but is not limited to, tamperheads having a single upper plate and tamperheads having any number of plungers and stripper shoes. Further, it should be noted that the mold 15 may include any number of mold cavities (not shown) of any shape and size, depending on the type of molded product which is to be produced.

As illustrated in FIG. 1, locking pins 9 may be attached to the tamperhead 5 and configured to interact with the compression beam (not shown) of the production machinery (not shown). These pins 9 may be used for attachment of the tamperhead 5 to the production machinery, as well as for alignment of the tamperhead 5 with a mold 15, as discussed in detail below. While FIG. 1 illustrates the use of two locking pins 9, it should be understood that any number of locking pins 9 may be employed according to the present invention without deviating from the scope and spirit of the present invention. For example, some smaller tamperheads may require only one locking pin 9 while larger tamperheads may require many more. Additionally, a manufacturer or operator of the machinery may desire to use any number of locking pins 9, depending on the desired strength and flexibility of the attachment of the tamperhead to the production machinery.

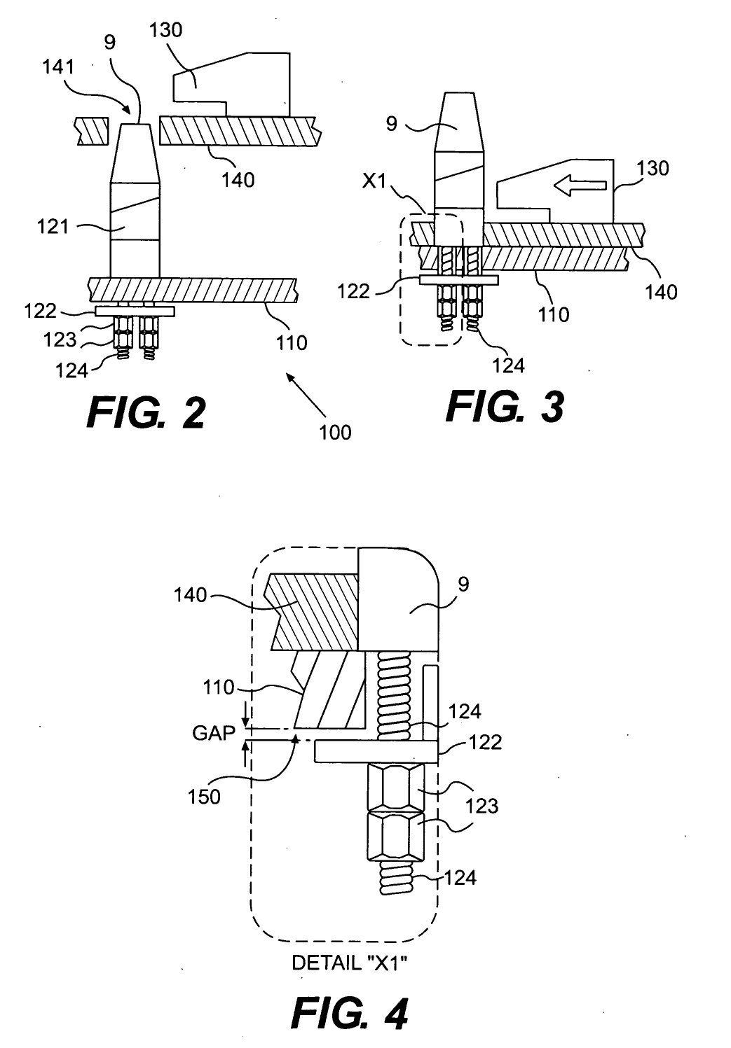

FIGS. 2-6 show a side view of a tamperhead locking system 100 according to one embodiment of the present invention. The figures illustrate a locking system 100 which may be used with each locking pin 9 illustrated in, and discussed with reference to, FIG. 1. The locking pin 9 may include a retaining groove 121 and, as illustrated in FIG. 1, may be used for attaching a tamperhead to production machinery. In the embodiment illustrated in FIGS. 2-6, the pin 9 may be connected to the upper plate 110 of a tamperhead. In alternative embodiments, the pin 9 may be attached to any portion of the tamperhead, depending on the type and structure of the tamperhead being used and the location of the attachment between the tamperhead and the production machinery.

The locking pin 9 discussed above may be used in conjunction with a machine head plate 140 having an opening 141. The machine head plate 140 may be a part of the production machinery (not shown) to which a tamperhead is to be attached. The production machinery may also include a ram fork 130 (as discussed above) which may move horizontally to engage with groove 121 of pin 9 to secure the tamperhead. As an alternative to the use of a ram fork 130, the production machinery may employ any known means for attaching to the pin 9 including, but not limited to, hooks, suction, bolts, pins and other means for connecting two machine pieces known to those of skill in the art.

In the embodiment illustrated in FIGS. 2-6, pin 9 may be attached to the upper plate 110 of a tamperhead using screws 124, nuts 123 and a washer 122. However, it is contemplated that any type of connection may be employed to connect pin 9 to the tamperhead as long as the functionality of this embodiment of the present invention is retained. It should be noted that screws 124 may be received by holes in the upper plate 110 which may be slightly larger in diameter than the diameter of the screws 124, as shown in FIGS. 3 and 4. This may permit pin 9 to move horizontally with respect to the upper plate 110 during attachment and alignment of a tamperhead in the production machinery.

During attachment and alignment of a tamperhead according to this embodiment of the present invention, pin 9 may be initially inserted into the machine head opening 141, as illustrated in FIG. 3. When pin 9 is inserted, the upper plate 110 may engage the machine head plate 140 so that the two are substantially abutted. Once pin 9 is fully inserted into the machine head plate 140, the retaining groove 121 may be in a position to receive the ram fork 130.

The initial engagement between the upper plate 110 and the machine head plate 140 is illustrated as detail X1 in FIG. 3. FIG. 4 shows a close-up view of detail X1 to illustrate the engagement between the plates 110 and 140 before ram fork 130 is moved into the locking position. It should be noted that the bottom of pin 9 may rest on the top surface of the upper plate 100. Additionally, because ram fork 130 is not yet engaged with groove 121, and plates 110 and 140 are not forced together using any vertical force, plate 110 may be allowed to move freely in the horizontal directions due to the larger diameter of the hole which receives screw 124. Further, it should be noted that, due to the fact that plates 110 and 140 are not fully engaged, a gap 150 may be present between the washer 122 and the bottom side of plate 110.

Permitting the insertion of pin 9 into opening 141 while still allowing for horizontal movement of upper plate 110 with respect to machine head plate 140 may permit the tamperhead to automatically align itself with a mold cavity during installation of the tamperhead into production machinery. After pin 9 is inserted into opening 141 and before ram fork 130 is engaged with groove 121, the plungers of the tamperhead may be placed in corresponding mold cavities located below the tamperhead (not shown) in the production machinery. If the initial insertion of pin 9 into opening 141 does not align the plungers with the cavities, the upper plate 110 of the tamperhead may be shifted horizontally about the screws 124 until the plungers are aligned with the mold cavities. This shifting may be done manually by an operator or may occur automatically when the mold cavities force the plungers to move horizontally. Alternatively, the plungers may initially be placed in the mold cavities and the production machinery may be lowered onto the pins. These alignment processes permit the tamperhead to move into alignment with the mold cavities until the ram fork 130 is engaged with groove 121, as discussed below.

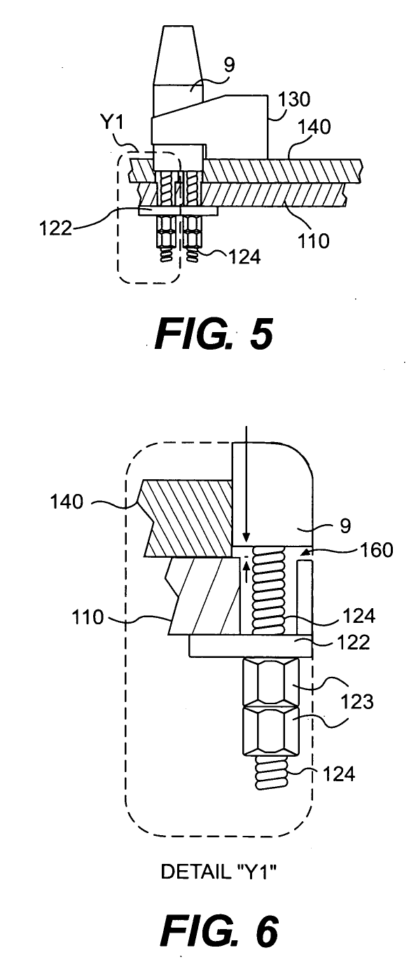

Once alignment of the tamperhead with the mold is complete, the ram fork 130 may engage with groove 121. Because groove 121 and ram fork 130 include angled edges, the movement of the ram fork 130 horizontally may cause pin 9 to lift, as shown in FIG. 5. When pin 9 is lifted in this manner, a vertical force may be exerted on washer 122, thereby causing washer 122 to exert a force against the bottom surface of plate 110. The friction between washer 122 and plate 110 caused by the force may effectively lock plate 110 against machine head 140, preventing further horizontal movement of the tamperhead.

The locking is illustrated as detail Y1 in FIG. 5. FIG. 6 shows a close-up view of detail Y1 to better illustrate the engagement between plates 110 and 140 after movement of the ram fork 130 into the locking position. As illustrated in FIG. 6, gap 150 may no longer exist and, instead, a gap 160 may be formed between the top surface of plate 110 and the bottom of pin 9 due to the upward forces exerted on pin 9 by ram fork 130.

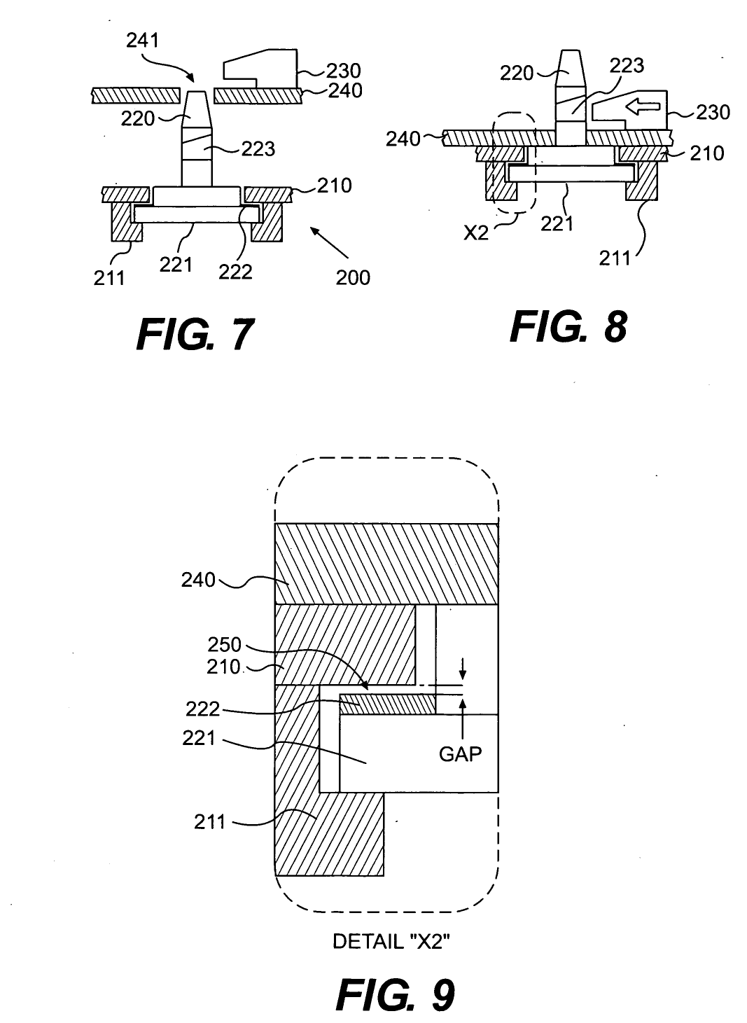

FIGS. 7-11 show a side view of a tamperhead locking system 200 according to another embodiment of the present invention. As with the above embodiments, the system 200 may be used with each locking pin of a tamperhead. As shown in FIGS. 7-11, a locking pin 220 may include a retaining groove 223 and may be connected to the upper plate 210 of a tamperhead.

As with previously discussed embodiments, the embodiment of the present invention shown in FIGS. 7-11 may be used in conjunction with a machine head plate 240 having an opening 241 which may be a part of the production machinery (not shown) to which the tamperhead is to be attached. The production machinery may also include a ram fork 230 which may move horizontally to engage with groove 223 of pin 220 to secure the tamperhead, as discussed above.

In the embodiment illustrated in FIGS. 7-11, pin 9 may be attached to a pin plate assembly 221 using any conventional means for secured including, but not limited to, screws, bolts, adhesive and welding. The pin plate assembly 221 may be attached to the upper plate 210 of a tamperhead using retaining shelves 211 which may movably hold the pin plate assembly 221 without detaching from shelves 211, as illustrated in FIG. 7. As such, pin plate assembly 221 and pin 220 may be permitted to move within the shelves 211 due to the clearance between plate assembly 221 and shelves 211. Pin plate assembly 221 may include rubber pads 222 attached between the upper surface of the pin plate assembly 221 and the lower surface of the upper head plate 210. While rubber pads are illustrated in FIGS. 7-11, it is contemplated that any material with a sufficient coefficient of friction may be used, as long as the functionality of the present invention is retained.

During attachment and alignment of a tamperhead according to the present invention, pin 220 may initially be inserted into the machine head opening 241, as illustrated in FIG. 8. After insertion of pin 220, plate 240 may engage plate 210 so that the two are substantially abutted. Once pin 220 is fully inserted into plate 240, retaining groove 223 may be in a position to receive ram fork 230.

The initial engagement between plate 210 and plate 240 is illustrated as detail X2 in FIG. 8. FIG. 9 shows a close-up view of detail X2 to illustrate the engagement between plates 210 and 240 before ram fork 230 is moved into the locking position. It should be noted that the bottom of pin plate assembly 221 may rest on top of the retaining shelves 211. Because ram fork 230 is not yet engaged with groove 223, and plates 210 and 240 are not forced together using any substantial vertical force, plate 210 may be allowed to move freely in the horizontal direction. Because of this attachment, the tamperhead may be permitted to “float,” permitting alignment of the tamperhead with a mold. Further, it should be noted that, due to the fact that pin plate assembly 221 is resting on retaining shelves 211, a gap 250 may be present between rubber pads 222 and the bottom side of plate 210.

By permitting the insertion of pin 220 into opening 241 while still allowing for horizontal movement of plate 210 with respect to plate 240, the tamperhead may automatically align itself with a mold cavity during installation of a tamperhead into production equipment. The alignment process used may be a similar process to those discussed above with respect to FIGS. 2-6.

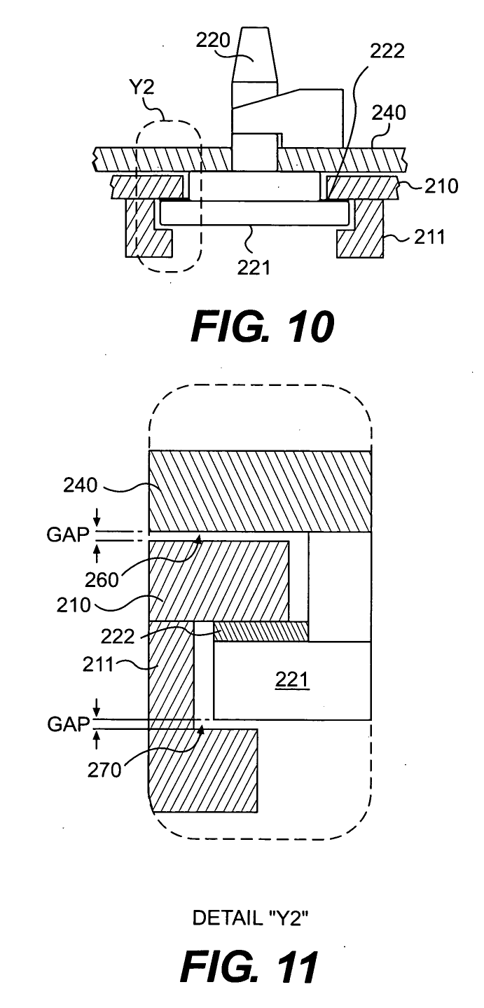

Once alignment of the tamperhead with the mold is complete, ram fork 230 may engage with groove 223, lifting pin 220 as shown in FIG. 10. When pin 220 is lifted in this manner, a vertical force may be exerted on pin plate assembly 221, thereby pulling pin plate assembly 221 toward plate 240 and causing rubber pads 222 to exert a force against the bottom of plate 210. The upwards force on pin plate assembly 221 and the friction between rubber pads 222 and plate 210 caused by this force may serve to effectively lock plate 210 with respect to pin 220, preventing further horizontal movement of the tamperhead with respect to plate 240. As such, the weight of the tamperhead is effectively rested on rubber pads 222. This is illustrated as detail Y2. FIG. 11 shows a close-up view of detail Y2 to better illustrate the engagement between plates 210 and 240 after movement of ram fork 230 into the locking position. As illustrated in FIG. 11, gap 250 may no longer exist and, instead, gaps 260 and 270 may be formed due to the upward forces exerted on pin 220 by ram fork 230.

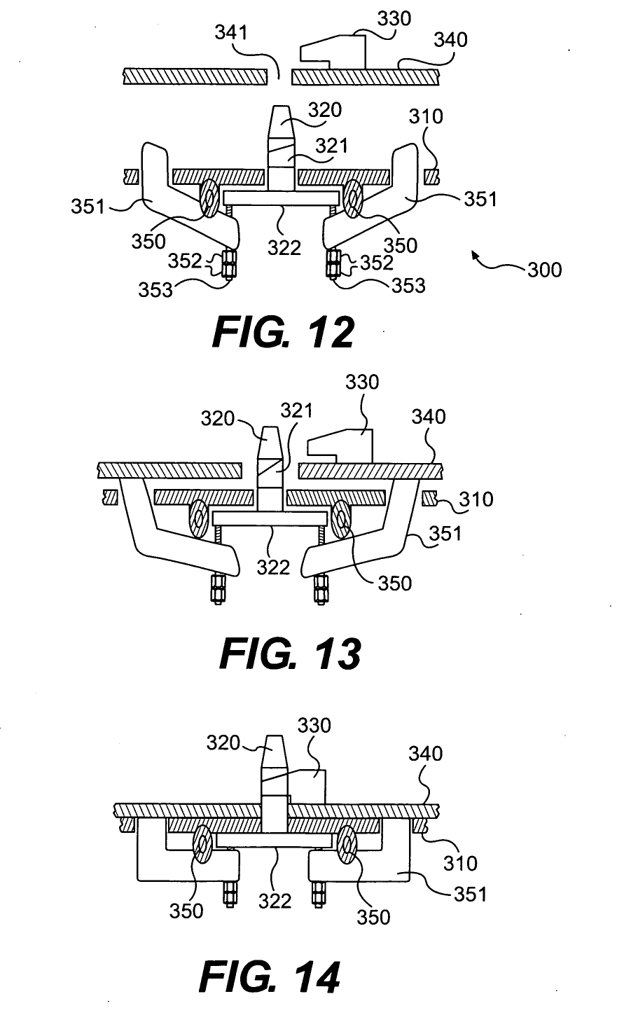

FIGS. 12-14 show a side view of a tamperhead locking system 300 according to yet another embodiment of the present invention. The system 300 may include a locking pin 320 having a retaining groove 321 attached to a floating plate 322. Similar to the embodiments of the present invention discussed above, pin 320 may be used in conjunction with a machine head plate 340 of a production machine may include an opening 341 for receiving locking pin 320. Additionally, the production machine may include a ram fork 330 for engaging with groove 321.

The floating plate 322 may rest on adjustment bolts 353 which may be held in place by locking nuts 352. The bolts 353 may be attached to, and be movable by, locking arms 351 which may also be attached to an upper head plate 310. As illustrated in the figures, locking arms 351 may rotate about fulcrums 350. Fulcrums 350 may include springs or a similar device which bias arms 351 so that, as shown in FIG. 12, the upper portion of arms 351 appear through holes in plate 310 prior to attachment of the tamperhead to the production machinery. It should be understood that the number and position of the bolts 353, locking arms 351 and fulcrums 350 are not intended to be limiting and the number and position of the bolts 353, arms 351 and fulcrums 350 may be changed without departing from the scope and spirit of the present invention.

It should be noted that the diameter of the hole in upper head plate 310 may be slightly larger than the diameter of pin 320 and arms 351 may movably hold plate 322, thus allowing pin 320 and plate 322 to move with respect to plate 310. Thus, the tamperhead may be aligned by aligning the top of pin 320 with opening 341 while plate 310 is permitted to move relative to pin 320 and plate 322. As illustrated in FIG. 12, this alignment may occur prior to the engagement of locking arms 351 with plate 340. By permitting the insertion of pin 320 into opening 341 while still allowing for movement of plate 310 with respect to plate 340, the tamperhead may automatically align itself with a mold cavity during installation of a tamperhead into production equipment, as discussed above with respect to FIGS. 2-6.

Floating plate 322, and thus pin 320 and plate 322, may be free to move relative to plate 310 until plates 310 and 340 begin to engage. As shown in FIG. 13, as the plates are moved closer to one another arms 351 may begin to engage with the bottom of plate 340, forcing them to rotate about fulcrums 350. By rotating arms 351 about fulcrums 350, arms 351 may move plate 322 towards plate 310. To ensure that plate 322 engages with plate 310, bolts 353 and nuts 352 may be used to adjust the height of plate 322 as it is moved upwards by arms 351.

Thus, once alignment of the tamperhead with the mold is complete and plates 310 and 340 are substantially abutted, the tamperhead may no longer be capable of moving horizontally because plate 322 is engaged with plate 310 due to the exertion of vertical forces by arms 351. At this point, ram fork 330 may engage with groove 321 to secure the tamperhead to the production machinery, as shown in FIG. 14.

The foregoing descriptions of specific embodiments of the present invention are presented for purposes of illustration and description. They are not intended to be exhaustive or to limit the invention to the precise forms disclosed. Obviously, many modifications and variations are possible in view of the above teachings. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims appended hereto, and by their equivalents.

What is claimed is:

1. A system for aligning a tamperhead with a mold in production machinery, the system comprising:
at least one pin movably held by the tamperhead; and
an opening in the production machinery associated with said at least one pin, said opening configured to receive said at least one pin;
wherein the tamperhead is permitted to move relative to said at least one pin when said at least one pin is received by said opening, thereby allowing the tamperhead to be aligned with the mold.

2. The system of claim 1, further comprising an attachment mechanism for attaching said at least one pin to the production machinery after said pin is received by said opening.

3. The system of claim 2, wherein the attachment of said at least one pin to the production machinery prevents the tamperhead from moving relative to said at least one pin.

4. The system of claim 2, wherein the attachment mechanism is a ram configured to attach to said at least one pin.

5. The system of claim 1, wherein said at least one pin is movably held by the tamperhead using at least one screw attached to a hole in the tamperhead, the hole having a diameter larger than the screw such that the tamperhead is capable of moving relative to the screw.

6. The system of claim 5, further comprising an attachment mechanism for attaching said at least one pin to the production machinery when said pin is received by said opening, whereby when the attachment mechanism attaches said at least one pin to the production machinery, the tamperhead is prevented from moving relative to the screw.

7. The system of claim 1, wherein said at least one pin is attached to a plate and wherein the tamperhead includes a shelf for movably holding the plate, such that the tamperhead is capable of moving relative to the plate.

8. The system of claim 7, further comprising an attachment mechanism for attaching said at least one pin to the production machinery when said pin is received by said opening, whereby when the attachment mechanism attaches said at least one pin to the production machinery, the tamperhead is prevented from moving relative to the plate.

9. The system of claim 1, wherein said at least one pin is attached to a plate and wherein the tamperhead includes at least one lever arm for movably holding the plate, such that the tamperhead is capable of moving relative to the plate.

10. The system of claim 9, wherein when said at least one pin is received by said opening, the at least one lever arm engages with the production machinery to prevent the tamperhead from moving relative to the plate.

11. A method for aligning a tamperhead with a mold in production machinery, the tamperhead having at least one movably held pin, the method comprising the steps of:
inserting the at least one movably held pin into an opening in the production machinery;
aligning the tamperhead with the mold by moving the tamperhead with respect to the at least one movably held pin; and
attaching the tamperhead to the production machinery after the tamperhead is aligned with the mold so that the tamperhead is prevented from further movement with respect to the at least one movably held pin.

12. The method of claim 11, wherein the step of attaching includes connecting a ram to the at least one movably held pin.

13. The method of claim 11, wherein the tamperhead includes at least one plunger and the mold includes at least one mold cavity.

14. The method of claim 13, wherein the step of aligning includes aligning the at least one plunger with the at least one mold cavity.

15. A system for aligning a tamperhead with a mold in production machinery, the system comprising:
an upper head plate attached to a tamperhead, said upper head plate having a first side and a second side;
an alignment pin located on the first side of said upper head plate;
a screw attached to said alignment pin;
an alignment opening in said upper head plate configured to receive said screw, said alignment opening having a diameter larger than said screw such that said upper head plate is capable of moving relative to said screw; and
a machine head plate having an associated opening, the associated opening being configured to receive said alignment pin;
wherein said upper head plate is permitted to move relative to said screw and said machine head plate when said alignment pin is received by the alignment opening, thereby allowing alignment of the tamperhead with a mold.

16. The system of claim 15, further comprising a locking mechanism attached to said machine head plate, said locking mechanism being configured to removably attach to said alignment pin after the tamperhead is aligned with the mold to prevent said upper head plate from moving relative to said screw and said machine head plate.

17. The system of claim 16, further comprising a washer attached to said screw, said washer being located on the second side of said upper head plate such that a space exists between said washer and the second side of said upper head plate and wherein said locking mechanism lifts said alignment pin, thereby forcing said washer to engage with the second side of said upper head plate.

18. The system of claim 15, further comprising:
a second screw attached to said alignment pin; and
a second alignment opening in said upper head plate configured to receive said second screw, said second alignment opening having a diameter larger than said second screw such that said upper head plate is capable of moving relative to said second screw.

19. A system for aligning a tamperhead with a mold in production machinery, the system comprising:
an upper head plate attached to a tamperhead;
an alignment pin;
an alignment plate attached to said alignment pin;
a pair of opposing alignment shelves attached to said upper head plate, said alignment shelves being configured to movably hold said alignment plate such that said upper head plate is capable of moving relative to said alignment plate; and
a machine head plate having an associated opening, the associated opening being configured to receive said alignment pin;
wherein said upper head plate is permitted to move relative to said alignment plate and said machine head plate when said alignment pin is received by the alignment opening, thereby allowing alignment of the tamperhead with a mold.

20. The system of claim 19, further comprising a locking mechanism attached to said machine head plate, said locking mechanism being configured to removably attach to said alignment pin after the tamperhead is aligned with the mold, thereby preventing said upper head plate from further movement relative to said alignment plate and said machine head plate.

21. The system of claim 20, wherein said locking mechanism lifts said alignment pin, thereby forcing said alignment plate to engage with said upper head plate to prevent said upper head plate from moving relative to said alignment plate.

22. A system for aligning a tamperhead with a mold in production machinery, the system comprising:
an upper head plate attached to a tamperhead, said upper head plate having an alignment position and a locking position;
an alignment pin;
an alignment plate attached to said alignment pin;
at least two lever arms pivotally attached to said upper head plate, each of said lever arms having a first end and a second end; and
a machine head plate having an associated opening, the associated opening being configured to receive said alignment pin;
wherein when said upper head plate is in the alignment position, the first end of each of said lever arms protrudes through an opening in said upper head plate and the second end of each of said lever arms is configured to movably hold said alignment plate such that said upper head plate is capable of moving relative to said alignment plate; and
wherein when said upper head plate is in the locking position, the first end of each of said lever arms is engaged with said machine head plate and the second end of each of said lever arms forces said alignment plate to engage with said upper head plate such that said upper head plate is prevented from moving relative to said alignment plate.

23. The system of claim 22, wherein when said upper head plate is in the locking position, said alignment pin is received by the alignment opening.

24. The system of claim 23, further comprising a locking mechanism attached to said machine head plate, said locking mechanism being configured to removably attach to said alignment pin when said upper head plate is in the locking position.

25. The system of claim 22, further comprising a spring for biasing the first end of each of said lever arms to protrude through the opening in said upper head plate.

26. The system of claim 22, further comprising an adjustment screw attached to the second end of each of said lever arms for adjusting the position of said alignment plate.

27. The system of claim 22, wherein said upper head plate is substantially abutted with said machine head plate when said upper head plate is in the locking position.
